(19) United States
(12) Patent Application Publication
(10) Pub. No.: US 2006/0117187 A1
(43) Pub. Date: Jun. 1, 2006

(54) Internet method of protecting subscriber information

(76) Inventors: Mike Hollatz, Huntley, IL (US); Mary Ellen Moser, Warrenville, IL (US); Dave Wesen, Channahon, IL (US)

Correspondence Address: Jon P. Christensen;Welsh & Katz, Ltd., 22nd Floor, 120 South Riverside Plaza, Chicago, IL, 60606, US

(21) Appl. No.: 10/999,533

(22) Filed: Nov. 30, 2004

(51) Int. Cl. H04L 9/32; H04L 9/00; G06K 9/00; H04K 1/00; G06F 17/30; G06F 15/16; G06F 7/04; G06F 7/58; G06K 19/00

(52) U.S. Cl. 713/182; 726/4

(57) ABSTRACT

A method and apparatus for providing subscriber information by a first party to a second party in conjunction with a call placed through the Internet. The method includes the steps of the first party determining a level of subscriber information of the first party that is to be provided to the second party in conjunction with the call through the Internet and the first party registering a set of information elements that correspond to the determined level of subscriber information with an Internet registration server for the benefit of the second party.

### FIELD OF THE INVENTION

The field of the invention relates to communication systems and more particularly to the Internet.

### BACKGROUND OF THE INVENTION

Methods of placing calls through the Internet are known. Under a first format, a call may be placed under an e-mail format. In this case, a user opens an e-mail application (e.g., OUTLOOK) on his terminal, enters an e-mail address, drafts a message and activates a SEND softkey.

In response, the OUTLOOK application may convert the message into a packet and transfer the packet through an Internet Service Provider (ISP) to a local router within the Internet. The local router, via reference to a routing table, may identify and transfer the packet to a local e-mail server of the recipient.

The recipient may receive a notice of the received e-mail when he/she next opens his/her OUTLOOK application. The recipient may activate an accept icon and the e-mail is delivered.

Alternatively, the user may open an instant messaging (IM) application. Opening the IM application may cause a buddys list to appear on the user's terminal. Within the buddys list may be an entry indicating the availability of people with whom the user may have had past communications. The user may select a party from the buddys list, enter a message and activate a send message.

As a still further alternative, a first party user may activate a voice-over-Internet-protocol (VoIP) application and enter a universal resource locator or indictor (URL or URI) of a second party. If the second party is available, the first and second parties may engage in a voice conversation through their respective terminals.

One of the difficulties in the use of e-mail, IM or VoIP is in the availability of user information. While some protocols, such as Session Initiation Protocol (SIP) provides a common REGISTRAR for registering the Internet addresses of active users, there is still no comprehensive method of obtaining additional information about Internet users. Because of the importance of the Internet, a need exits for a method through which a user may make additional information available to other users.

### SUMMARY

A method and apparatus for providing subscriber information by a first party to a second party in conjunction with a call placed through the Internet. The method includes the steps of the first party determining a level of subscriber information of the first party that is to be provided to the second party in conjunction with the call through the Internet and the first party registering a set of information elements that correspond to the determined level of subscriber information with an Internet registration server for the benefit of the second party.

### BRIEF DESCRIPTION OF THE DRAWINGS

FIG. 1 is a block diagram of a system for providing subscriber information from a first party to a second party in accordance with an illustrated embodiment of the invention; and

FIG. 2 is a call control window that may be used with the system of FIG. 1.

### DETAILED DESCRIPTION OF AN ILLUSTRATED EMBODIMENT

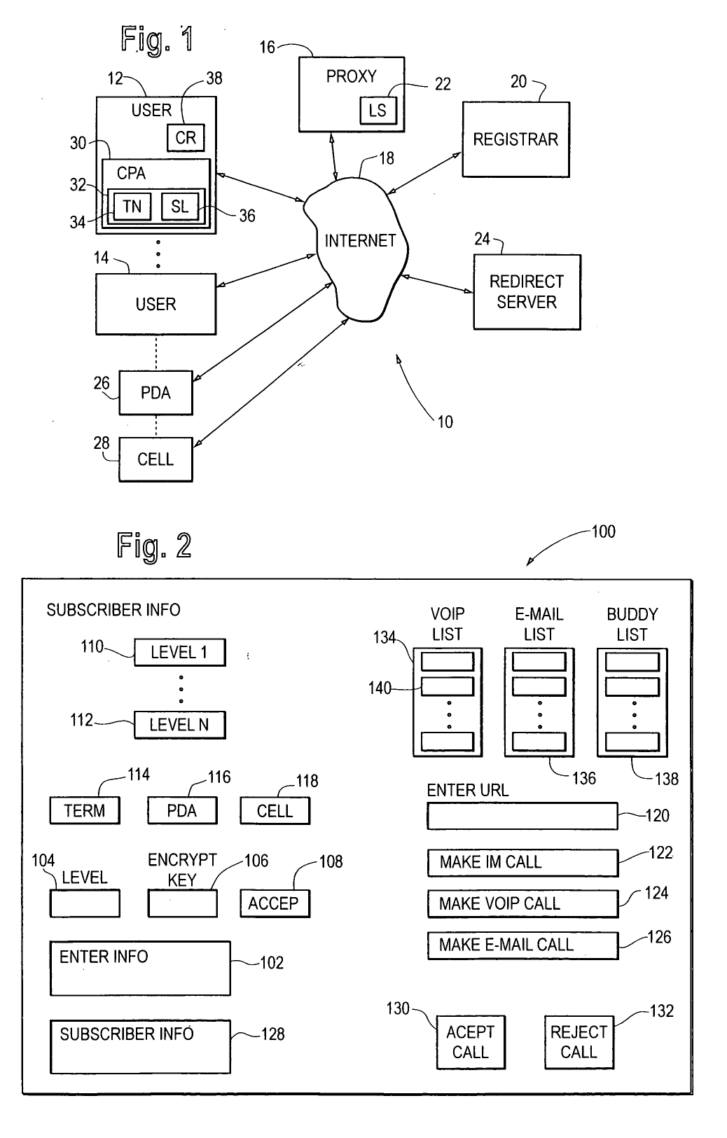

FIG. 1 depicts a system 10 for providing subscriber information to other Internet users under an illustrated embodiment of the invention. Under illustrated embodiments, users may make a predetermined amount of information available in conjunction with calls. The predetermined amount of information allows users to preserve their privacy by limiting the information given to unknown third parties while providing as much information as desired to known, trusted parties.

The system 10 may operate under a Session Initiation Protocol (SIP) as defined by Internet Engineering Task Force RFC #3261. As such, communication protocols may be negotiated, calls set up and torn down as described in IETF RFC #3261.

Included within the system 10 may be one or more user terminals 12, 14, a proxy server 16 and a REGISTRAR server 20, all operating through the Internet 18. While the system 10 shows only two users 12, 14, it should be assumed that any number of users 12, 14 may be present within the system 10.

Each user 12, 14 of the system 10 may be identified by their own unique SIP address. In this regard, a SIP address is similar to an e-mail address, except that it is provided under a SIP format (e.g., sip:userID@mydomain.com). The userID may be either a user name or an E.164 address.

The users 12, 14 may register with the REGISTRAR server 20 using their assigned SIP addresses. The REGISTRAR server 20 provides this information to the location server 22 upon request.

To initiate a call, a user (caller) at a first party terminal (e.g., 12) may send a SIP INVITE to a SIP server (e.g., the proxy server 16 or redirect server 24. The INVITE may include the Internet address of the caller 12 (in the “From” header field) and the address of the intended callee 14 (in the “To” header field). The INVITE may also include a proposed communication protocol (e.g., IM, VoIP, etc.).

The SIP server 16 or 24 may return a SIP OK and forward the SIP INVITE to the second party callee 14. The terminal 14 of the callee 14 may return a SIP RINGING message acknowledging the call. If the callee 14 accepts the call, the terminals 12, 14 may negotiate a protocol and a communication session may begin between the first party caller and second party callee.

If the callee 14 is not available or does not choose to accept the call, the callee 14 may reject the INVITE. The callee 14 then has the option of calling back later or searching for another communication path.

One method of finding another communication path is to search the SIP REGISTRAR for other communication devices associated with the Address of Record of the callee 14. If the callee 14 has registered another device, the caller 12 may retrieve and initiate a call through the alternate communication device.

In general, the SIP REGISTRAR 20 provides mobility to a user by providing a means through which a user may register (and change) a preferred communication device at will. For example, from time to time, a user (e.g., working in his office on a terminal 14) may decide to leave his office and to transfer his calls from the terminal 14 to another device (e.g., a personal digital assistant (PDA) 26, cell phone 28, etc.).

The user may accomplish the redirection of calls using one or more SIP REGISTER message (as defined by the IETF RFC #3261) sent to the REGISTRAR server 20. Included within the SIP REGISTER message may be one or more CONTACT headers that may be used to convey the URL or URI of the alternate communication device 26, 28.

In general, the contents of SIP REGISTRAR 20 (i.e., the registration messages of users) may be retrieved by SIP servers 16, 24 or by other users 12, 14. Retrieval of the contents of the SIP REGISTER messages may be accomplished using the SIP SUBSCRIBE and NOTIFY features of SIP.

What has not been generally recognized in the art is that the information saved under the CONTACT headers of a SIP REGISTER message need not be limited to Internet addresses. In fact, a number of different formats and types of subscriber information may be included in the information field of each of the CONTACT headers.

As used herein, subscriber information refers to personal information about the user. Subscriber information does not refer to the user's Internet address.

For example, a first level of subscriber information provided may include a telephone number of the user along with the SIP address of the registered device. A second level of subscriber information may include the telephone number and address of the user along with the SIP address of the registered device.

The levels of subscriber information may be registered as part of a one-time event or registered on a per-call basis. For example, if the user 12 is a SIP telephone and the user 12 wishes to place a carry-out order to a pizza purveyor, then the user 12 may specify the first level of subscriber information. The use of the first level of subscriber information (with only the telephone number) allows the user to order a pizza (with his telephone number displayed as ANI information to the pizza purveyor) yet still preserves the privacy of the user 12.

In other calls (e.g., to the fire department), the user 12 may wish to provide the second level of subscriber information including both the user's home telephone number and address. In calls to the user's bank, the user may include his home telephone number, his address and his bank account number or other credit information.

In general, the user terminals 12, 14 may include a call processing application 30 that may be used as a first level control of subscriber information that is made available to other users. FIG. 2 shows a call control window 100 that may appear on a display of the terminal 12, 14 of a user and may be used in conjunction with the call control application 30.

The call processing application 30 may be used to associate levels of subscriber information with calls proactively, reactively or manually. Within the application 30 may be a number of files 32 that contain a calling address (e.g., telephone number, URL, URI, etc.) and an identifier of a level of subscriber information. In effect, the call processing application 30 may act as an automated caller that either places icons on a display of the user 12 with each called number and that places calls to the callee as the icons are activated or the application 30 may change levels of subscriber information as the identify of the called party is detected by the call control application 30 (via entry of a destination identifier by the caller) during a call.

The terminal 12, 14 of a user may also be provided with a call reject application 38 that changes the level of subscriber information in the event of incoming calls. In this case, if the user 12, 14 should choose to reject an incoming call, the user 12, 14 may also choose to block any subsequent contacts through other channels (e.g., the mail) from the caller. The call reject application 38 may do this by detecting activation of the call reject button by the user and by immediately changing the level of subscriber information to the first or lowest level.

Turning now Lo the call control window 100, an explanation will be provided of the use of the call control application 30. As shown in FIG. 2, the call control window 100 may include a subscriber information entry window 102 for entry of subscriber information. Another widow 104 may be provided that allows a user to enter a relative information security level indicator. A third window 106 is provided for the user to enter a encryption key where the registered information requires authentication for retrieval. A fourth window 108 may be provided to accept the subscription information disclosure file for that particular use level. As each file is accepted, it may be saved in memory in association with a corresponding level selector 110, 112. As above, the lowest level selector 110 may contain only the user's URL and telephone number. The highest level selector 112 may contain the user's URL, telephone number, address and other personal information.

The control of subscriber information that is available within the REGISTRAR 20 in any instant of time may be controlled in any of a number of ways. Under a first method, the user may simply activate a level softkey 110, 112 followed by activation of a softkey 114, 116, 118 associated particular communication device 14, 26, 28. Following activation of the softkey 114, 116, 118, the call processing application may immediately compose a register message for that communication device 14, 26, 28 that includes the subscriber information entered for that level softkey 110, 112 and sends the registration message to the REGISTRAR 20.

To cancel registration, the user may simply activate a device key 114, 116, 118 a second time or active a device key 114, 116, 118 without the prior selection of a level key 110, 112. In this way, a user can register any subscriber information that he/she wants or cancel registration of any particular device 12, 14, 26, 28 on an almost instantaneous basis.

As an alternative to the static registration of subscriber information with the REGISTRAR 20, the user may choose to register a selected level of subscriber information for only the duration of a call. In this case, the user may enter an Internet address into an interactive window 120, select an information level by activating a level softkey 110, 112 and select the format of the call by activating a MAKE CALL button 122, 124, 126 under the proper format.

In response, the call processing application 30 may register the associated Internet device 12, 14, 26, 28 with the REGISTRAR 20 with the proper level of subscriber information and proceed to make the call. Making the call may mean activating an associated communication application (e.g., IM, VoIP, OUTLOOK, etc.), transferring the Internet address entered through the window 120 to the communication application and causing the application to set up the communication channel. In effect the call processing application acts as a channel set up robot in forming the communication channel with the appropriate level of subscriber information.

As the channel is set up from the caller to the callee, the callee may retrieve the subscriber information from the REGISTRAR 20 in anticipation of accepting the call. In the case where the call control window 100 is used by the callee, the receipt of a SIP INVITE by the call control processor 30 may cause the call control processor 30 to send a SIP SUBSCIBE message to the REGISTRAR 20 requesting a file registered by the caller for the requesting device.

In this case, the subscriber information of the caller may be displayed in a caller window 128. The callee may accept or reject the call based upon his/her perception of the information displayed within the window 128.

If the callee accepts the call, the callee may activate an accept softkey 130. In response the call may be negotiated and set up under conventional SIP processes.

If the callee chooses to reject the call, the callee may activate a reject softkey 132. Activation of the reject softkey 132 may cause the call control processor 30 to immediately reduce the level of subscriber information on other communication channels as described above.

In the case of a private party, the subscriber information may provide the basis of whether the callee accepts the call or not. In the case of the bank, the presence of an account number within the subscriber information may facilitate the efficient processing of the call.

In addition to providing personal information, a user 12, 14, 26, 28 may also require authentication in order for another user to retrieve registered information. In the the case of the bank and account number, the user 12, 14 may send a registration message to the REGISTRAR 20 that includes the personal information (i.e., the bank account number) and an authentication key that may have been previously provided to the bank. The user of the authentication key may allow authorized parties (i.e., the bank) to access the subscriber information without fear of the information falling into the wrong hands.

Under another illustrated embodiment, the manual selection of a subscriber information level through activation of a softkey 110, 112 during a previous call may result in the information level being stored in a favorites list 134, 136, 138. Subsequent activation of an entry (e.g., 140) may result in the set up of another call under the same format and with the same level of subscriber information.

A specific embodiment of a method and apparatus for providing subscriber information has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of providing subscriber information by a first party to a second party in conjunction with a call placed through the Internet, such method comprising:
a terminal of the first party determining a level of subscriber information of the first party that is to be provided to the second party in conjunction with the call through the Internet; and
the terminal of the first party registering a set of information elements that correspond to the determined level of subscriber information with an Internet registration server for the benefit of the second party.

2. The method of providing subscriber information as in claim 1 further comprising the first party registering the subscriber information before the call.

3. The method of providing subscriber information as in claim 1 further comprising the first party registering the subscriber information during the call.

4. The method of providing subscriber information as in claim 1 further comprising the first party placing the call to the second party.

5. The method of providing subscriber information as in claim 1 further comprising the second party placing the call to the first party.

6. The method of providing subscriber information as in claim 1 wherein the elements of the subscriber information further comprise only a name and telephone number of the first party.

7. The method of providing subscriber information as in claim 1 wherein the elements of the subscriber information further comprise a name, a telephone number and an address of the first party.

8. The method of providing subscriber information as in claim 1 wherein the elements of the subscriber information further comprise credit information.

9. The method of providing subscriber information as in claim 1 further comprising the first party instructing a controller of the registration server to request authentication from the second party before the controller allows access to the registered subscriber information.

10. The method of providing subscriber information as in claim 1 further comprising the first party registering subscriber information on a first level containing a first set of information elements for a first device used by the first party and subscriber information on a second level containing a second set of information elements for a second device used by the first party.

11. An apparatus for providing subscriber information by a first party to a second party in conjunction with a call placed through the Internet, such apparatus comprising:
means for determining a level of subscriber information of the first party that is to be provided to the second party in conjunction with the call through the Internet; and
means for registering a set of information elements that correspond to the determined level of subscriber information with an Internet registration server for the benefit of the second party.

12. The apparatus for providing subscriber information as in claim 11 further comprising means within a terminal of the first party for registering the subscriber information before the call.

13. The apparatus for providing subscriber information as in claim 11 further comprising means for registering the subscriber information during the call.

14. The apparatus for providing subscriber information as in claim 11 wherein the elements of the subscriber information further comprise only a name and telephone number of the first party.

15. The apparatus for providing subscriber information as in claim 11 wherein the elements of the subscriber information further comprise a name, a telephone number and an address of the first party.

16. The apparatus for providing subscriber information as in claim 11 wherein the elements of the subscriber information further comprise credit information.

17. The apparatus for providing subscriber information as in claim 11 further comprising means for instructing a controller of the registration server to request authentication from the second party before the controller allows access to the registered subscriber information.

18. The apparatus for providing subscriber information as in claim 11 further comprising means for registering subscriber information on a first level containing a first set of information elements for a first device used by the first party and subscriber information on a second level containing a second set of information elements for a second device used by the first party.

19. An apparatus for providing subscriber information by a first party to a second party in conjunction with a call placed through the Internet, such apparatus comprising:
an interactive window adapted to recieve a level of subscriber information of the first party that is to be provided to the second party in conjunction with the call through the Internet; and
a call processing application that registers a set of information elements that correspond to the determined level of subscriber information with an Internet registration server for the benefit of the second party.

20. The apparatus for providing subscriber information as in claim 19 further comprising a registration softkey that registers the subscriber information before the call.

21. The apparatus for providing subscriber information as in claim 19 wherein the elements of the subscriber information further comprise only a name and telephone number of the first party.

22. The apparatus for providing subscriber information as in claim 19 wherein the elements of the subscriber information further comprise a name, a telephone number and an address of the first party.

23. The apparatus for providing subscriber information as in claim 19 wherein the elements of the subscriber information further comprise credit information.

24. The apparatus for providing subscriber information as in claim 19 further comprising an authentication key used to obtain authentication from the second party before the controller allows access to the register subscriber information.

25. The apparatus for providing subscriber information as in claim 19 further comprising a first level of subscriber information that contains a first set of information elements for a first device used by the first party and a second level of subscriber information containing a second set of information elements for a second device used by the first party.
